(19) United States
(12) Patent Application Publication
(10) Pub. No.: US 2014/0165777 A1
(43) Pub. Date: Jun. 19, 2014

(54) SYSTEMS AND METHODS FOR SECURING A ROTOR APPARATUS

(71) Applicant: Active Power, Inc, Austin, TX (US)

(72) Inventors: James Andrews, Austin, TX (US); Robert Hudson, Austin, TX (US)

(73) Assignee: ACTIVE POWER, INC, Austin, TX (US)

(21) Appl. No.: 14/108,758

(22) Filed: Dec. 17, 2013

Related U.S. Application Data
(60) Provisional application No. 61/746,440, filed on Dec. 27, 2012.
(60) Provisional application No. 61/739,548, filed on Dec. 19, 2012.
(60) Provisional application No. 61/738,931, filed on Dec. 18, 2012.

(51) Int. Cl. H02K 7/02; H02K 15/02

(52) U.S. Cl. CPC H02K 7/025; H02K 15/02
USPC 74/572.11; 29/598

(57) ABSTRACT

Rotors apparatus usable in energy storage devices and power systems include a plurality of laminations having a center and at least one orifice spaced a distance from the center, and at least one fastener extending through the orifice. The one or more fasteners, the one or more orifices, or combinations thereof are sized to reduce contact between the fasteners and the laminations during rotation of the rotor apparatus. The fasteners and orifices can define an envelope, corresponding to the maximum space able to be occupied by a fastener to reduce contact between the fastener and the laminations, and one or more fasteners can have a volume of material less than the volume of the envelope to reduce bending forces on the fastener.

### CROSS REFERENCE TO RELATED APPLICATIONS

The present application claims priority to the U.S. Provisional Application for Patent having the Application Ser. No. 61/738,391, filed Dec. 17, 2012; the U.S. Provisional Application for Patent having the Application Ser. No. 61/739,548, filed Dec. 19, 2012; and the U.S. Provisional Application for Patent having the Application Ser. No. 61/746,440 filed Dec. 27, 2012. Each of the above-referenced applications is incorporated by reference herein in its entirety.

### FIELD OF THE PRESENT DISCLOSURE

Embodiments usable within the scope of the present disclosure relate, generally, to rotor apparatus, e.g., for use in rotating machines and methods of constructing and/or assembling such assemblies, and more specifically, to rotors made from layered materials (e.g., laminations) usable in flywheel alternators and/or similar energy storage devices.

### BACKGROUND

Numerous electrical machines operate by means of interaction between a magnetic field and a ferromagnetic (e.g., magnetically permeable) rotating element (e.g., a rotor). For example, a flywheel alternator, usable for the storage and retrieval of energy, can typically include a large-diameter, heavy rotor, able to be rotated at high speed, to maximize the amount of energy that can be stored in the rotor. A conventional flywheel alternator will include a solid rotor, e.g., a rotor manufactured from a single piece of metal (or multiple joined pieces of metal) via a forging or casting process. The creation of solid rotors can be an expensive and time-consuming process, requiring specialized materials to be subjected to multiple casting and/or machining processes.

In other types of devices, laminated rotors, formed by stacking a plurality of relatively thin laminations (e.g., cut-outs removed from thin pieces of sheet metal), have been used as less expensive alternatives to solid rotors; however, for many reasons, use of conventional laminated rotors in flywheel alternators and/or other devices having precise operational and/or structural specifications and narrow ranges of dimensional tolerances is unsuitable due to inherent variations and imperfections in such materials.

For example, a laminated rotor is conventionally produced by removing multiple laminations (e.g., via a stamping or laser cutting process) from rolled steel or a similar, generally thin material. Each lamination will be generally thin, having a width equal to that of the sheet of material, and a plurality of laminations can be stacked and secured together to form a rotor. FIG. 1A illustrates one example of such a process, depicting a top view of a piece of rolled steel material (10) having a width (W) and a length (L). The outlines of six laminations (12A, 12B, 12C, 12D, 12E, 12F) are depicted along the length of the material (10), each lamination outline abutting each adjacent outline without overlapping the adjacent outline, and each lamination outline having a width less than the width (W) of the material (10). While the shape and/or configuration of the laminations could vary depending on the nature of the laminated rotor to be constructed, the depicted laminations (12A-12F) are each shown having eight protrusions of which an exemplary protrusion (14) is labeled for reference, with eight arcuate notches disposed between adjacent protrusions, of which an exemplary notch (16) is labeled for reference. While FIG. 1A shows six laminations (12A-12F) along the depicted length (L) of material (10), it should be understood that in practice, rolled material having any desired length could be used, from which any number of laminations could be removed (e.g., stamped, laser cut, etc.)

While rotors formed from the depicted laminations (12A-12F) may be usable for some applications, imperfections in such laminations can render them unsuitable for use in flywheel alternators and/or similar devices having precise specifications and a narrow range of tolerances. Specifically, sheets of rolled material are typically produced using a long roller that is secured at both ends. As such, during production (e.g., rolling) of a sheet of material, the roller will have a tendency to bend and/or flex slightly along the middle thereof, such that the resulting sheet of rolled material (10) will have a variable thickness along its width (W), namely, a thicker region near the center and thinner regions toward the edges thereof. Wider sheets of material can exhibit a greater variation in thickness across their width than narrower sheets of material; however, variations in thickness are observed in nearly all sheets of rolled material independent of the width thereof. FIG. 1B illustrates this concept, depicting a diagrammatic side view of the piece of rolled steel material (10) shown in FIG. 1A. Specifically, the material (10) is shown having a first thickness (T1) at its left and right edges (18A, 18B), and a second, greater thickness (T2) at its centerline (20). The edges (22A, 22B) of a laminate outline are shown, for reference, illustrating that a laminate removed from the material (10) would, similarly, have a thicker region near the center thereof, and thinner regions near the edges thereof.

Of additional note, a rolled sheet of material can also slightly vary in thickness along the length (L) thereof. As such, a laminate removed from a first portion of a sheet of material (e.g., laminate (12A)) may differ in thickness from a laminate removed from a portion of the material farther along the length thereof (e.g., laminate (12F)), independent of the variations in thickness along each individual laminate.

It should be understood that FIG. 1B depicts a heavily exaggerated side view of the rolled steel material (10), and that variations in thickness along the width (W) thereof can typically be very small (e.g., a fraction of a millimeter). However, when multiple laminates (e.g., thirty-two laminates) having thicker and thinner regions are stacked to form a rotor, the cumulative effect of the imperfections in each individual laminate can cause the resulting rotor to have a thickness variation unsuitable for use in a flywheel alternator or similar type of device. For example, a rotor constructed from thirty-two laminations, each having a thickness variation of 0.004 inches (0.01 cm) can have an overall thickness at the edge thereof that differs by as much as 0.128 inches (0.325 cm) from that at the center. Further, this variation in thickness may be non-uniform around the periphery of the rotor. For large-diameter, high speed rotors, these variations can generate unacceptable imbalances. Additionally, depending on the orientation of individual laminations within the rotor, spaces between laminations may exist, further contributing to improper balance and movement of individual laminations during use of the rotor.

FIG. 2 depicts a diagrammatic side view of a laminate (12A) removed from the sheet of rolled steel material, having a thickness (T2) at its centerline (21) generally equal to that of the sheet of material at the centerline thereof, and a thinner region (T3) at the edges (22A, 22B) thereof. FIG. 2 illustrates an additional difficulty inherent in the construction of a laminated rotor. Specifically, when stamping and/or otherwise removing a laminate (12A) from a larger sheet of material, the edges (22A, 22B) thereof can become deformed, and the resulting deformations (24A, 24B), while individually small, can cumulatively produce a significant imbalance in a resulting rotor when a large number of deformed laminates are used. For example, depending on the orientation of individual laminations, the presence of deformations and/or variations in thickness in the laminations, can create space between the laminations varying about the rotor periphery from zero to more than 0.004 inches (0.01 cm).

For laminated construction techniques to be usable to produce rotors intended for use in flywheel alternators and similar devices, methods to compensate for the variation in the thickness of rolled/sheet materials across both the width and length thereof, as well as methods to compensate for the possible presence of deformities in the laminates created by the removal process should be addressed.

As described above, large diameter, heavy rotors, operated at high rotational speeds, such as those used in flywheel alternators, must be carefully balanced so that the center of mass of the rotor is located at the axis of rotation. An unbalanced rotor can cause failure of the bearings and/or of the rotor structure itself, or other associated components. If the imbalance exceeds the capacity of any compensating features built into the rotor, the entire rotor assembly could be rendered unusable. Thus, rotors used in flywheel alternators are typically manufactured within tight dimensional tolerances, not typically attainable using conventional lamination manufacturing and construction techniques. For example, homopolar flywheel alternators are described in U.S. Pat. Nos. 5,969,497 and 5,929,548, both of which are incorporated by reference herein in their entirety. These patents describe alternators that can use, for example, a solid rotor machined to tight tolerances, which can represent a significant expense.

Flywheel energy storage units are usable in various types of uninterruptable power supply systems (“UPS”), such as those described in U.S. Pat. No. 5,731,645, which is incorporated by reference herein in its entirety. FIG. 3 depicts a diagram illustrating an embodiment of a UPS (26) which, in operation, receives primary power (IN), typically from a power company or similar source, and provides alternating current power to a load (OUT). A flywheel storage unit (28), which can include any manner of flywheel energy conversion device, e.g., having a field-controllable generator for providing short-term, back-up power (such as a homopolar flywheel alternator), is shown in electrical communication with other system components. The depicted UPS (26) further includes an input line monitor (30), an output line monitor (34), and a direct current bus monitor (36), any or all of which can directly and/or indirectly monitor disruptions in primary power. The depicted UPS (26) is further shown having a field coil controller (38), a plurality of rectifiers (40), and an inverter (42), which can include transistor timing and driving circuitry and/or various associated components. The operation of the UPS (26) is described in detail in U.S. Pat. No. 5,731,645, incorporated by reference above. If emergency power is required for a long time period (e.g., longer than a period for which kinetic energy stored in the flywheel storage unit (28) can be supplied), a transfer switch (44) can be actuated to place the supply lines into communication with a standby power source (46), such as a diesel or natural gas generator, or other usable power source.

FIG. 4 depicts a diagram of an embodiment of a UPS (48) similar to that described in U.S. patent application Ser. No. 13/946,036, filed Jul. 19, 2013, which is incorporated by reference herein in its entirety. The depicted UPS (48) can, for example, receive primary power from a three-phase alternating current utility source (50), and receive backup power from a backup alternating current generator (52). The backup generator (52) can include, for example, any manner of flywheel energy storage device, motor, and/or generator (e.g., a homopolar flywheel alternator). The UPS (48) is shown having a static alternating current switch (54) and a backup power conditioner (56). The depicted backup power conditioner (56) includes a flywheel inverter (58), a storage capacitor (60), and a utility converter (62). A controller (64) is usable to monitor the inputs and outputs to and from the UPS (48) and control the static alternating current switch (54) and the backup power conditioner (56) to provide uninterrupted power to the loads (66).

FIG. 5 depicts an exploded perspective view of an integrated UPS system (68) that includes a flywheel energy storage device (70) (e.g., a homopolar flywheel alternator) integrated with UPS electronics (72) (e.g., a UPS electronics unit) and a cooling apparatus (74) (e.g., a cooling fan assembly). One or more embodiments of such a UPS are described in U.S. Pat. No. 6,657,320, which is incorporated by reference herein in its entirety. The depicted UPS (68) is usable to provide continuous power to a load using the flywheel energy storage unit during a short term power outage of utility power, and from the utility power source after the short term power outage ends, under the control of the UPS electronics (72) mounted within the housing. An additional source of power, such as a motor-generator set and/or batteries, can be used to provide continuity in power delivery for power outages that last longer than a period of time than what can be accommodated by the flywheel energy storage device (70).

### BRIEF SUMMARY OF THE INVENTION

Embodiments usable within the scope of the present disclosure relate to rotor apparatus, e.g., a flywheel rotor usable within flywheel alternators, UPS systems, and/or other similar devices and assemblies, and methods for forming such apparatus, e.g., using lamination construction techniques, such as the orientation and/or stacking of a plurality of layered components to form a product.

A rotor apparatus can include a plurality of laminations, e.g., oriented in vertical alignment, having one or more orifices extending therethrough a distance from the center of the laminations. One or more fasteners (e.g., studs or similar members) can extend through corresponding orifices, e.g., to secure the laminations and/or adjacent structures, the orifice(s) and/or fastener(s) being sized to reduce contact between the fastener(s) and the laminations during rotation of the rotor apparatus. For example, when one or more fasteners are off-set from the center of the rotor assembly, rotation thereof can impart a centrifugal force to the fasteners, causing bending thereof. The dimensions of the fasteners and/or that of the orifices extending through the laminations can reduce and/or prevent the fasteners from contacting the laminations.

A first plate can be positioned in contact with a first side of the laminations, a second plate can be positioned in contact with a second side of the laminations, and the one or more fasteners can be engaged with the plates (e.g., by extending into orifices in the plates aligned with those in the plurality of laminations), to compressively retain the lamination (e.g., to prevent relative movement therebetween). In an embodiment, the fasteners and/or the orifices in the plates can be sized to enable an interference fit between the plates and fasteners. Nuts and/or similar securing members can be engaged to the fasteners (e.g., via a threaded engagement) to apply an axial load to the fasteners and/or secure the fasteners to limit movement thereof.

In an embodiment, laminations can be formed by removal from a sheet of material (e.g., rolled steel or another similar material). In an embodiment one or more laminations can have a first region with a thickness greater than that of a second region. For example, as described above, a sheet of material (e.g., rolled steel or another similar material) may include a centerline having a thickness greater than one or more other portions thereof. Laminations, each spaced an equal distance from the centerline of the sheet could be removed (e.g., via stamping, laser cutting, and/or another similar process), such that each lamination possesses a first region thicker than a second. In an embodiment, production of a plurality of laminations via such a process can generate laminations that are generally identical to one another.

A first lamination can be oriented above a second lamination (e.g., stacked and/or layered and/or otherwise positioned thereon) such that the first (e.g., thicker) region of the first lamination is above the second (e.g., thinner) region of the second lamination, and the second (e.g., thinner) region of the first lamination is above the first (e.g., thicker) region of the second lamination. Orientation of the first and second laminations in this manner forms a stacked pair of laminations which, in an embodiment, can have upper and lower surfaces that are generally flat due to the orientation of the first and second laminations and the fact that such an orientation can account for regions of varying thickness in the material from which the laminations are removed.

In an embodiment, the first and second laminations can also be oriented such that the bottom face of the first lamination contacts the top face of the second lamination (e.g., such that the top and bottom faces of each lamination are oriented in the same direction). Such an embodiment can be useful, for example, to accommodate the presence of deformations such as those shown in FIG. 2, by enabling laminations that are slightly curved and/or otherwise modified via the removal process to nest within one another.

To account for the fact that laminations may vary slightly in thickness due to variations in thickness along the length of a rolled material, in an embodiment, stacked pairs of laminations can be placed in opposing and/or offset orientations relative to one another. For example, each successive stacked pair of laminations can be rotationally offset from the next adjacent pair by a known angle. Visible indicators on the laminations can be used to facilitate orienting the stacked pairs relative to one another, as well as orienting the individual laminations relative to one another.

The orifices within the laminations through which the fasteners pass, and/or the fasteners themselves, can define an envelope, which corresponds to a maximum space able to be occupied by a fastener while reducing contact between the fastener and the laminations during rotation of the rotor apparatus. In an embodiment, one or more fasteners can have a volume of material less than the volume of the envelope. For example, a fastener could have an annular shape, e.g., that of a cylinder with an axial bore from which material has been removed. In another embodiment, a fastener could have an “I-beam” shape, e.g., a generally cylindrical body having portions in the periphery thereof from which material has been removed. Generally, removal of material from the “envelope” occupied by a fastener can reduce the bending forces on the fastener, such that a greater angular velocity of the rotor apparatus can be achieved while reducing contact between the fasteners and the laminations.

Power systems can be assembled that include, the laminations, plates, and/or fasteners described above, positioned in association with at least one non-rotating magnetically permeable member such that a gap is defined between the non-rotating member and the plates and/or laminations. An armature coil can be positioned in one or more of such gaps, and a flux coil can be used to induce a flux in the laminations, to plate, bottom plate, and/or non-rotating members, such that rotation of the rotor assembly induces a voltage in the armature coil.

### BRIEF DESCRIPTION OF THE DRAWINGS

FIG. 1A depicts a top view of a sheet of rolled material having outlines of laminations thereon.

FIG. 1B depicts a side view of the sheet of rolled material shown in FIG. 1A.

FIG. 2 depicts a side view of a lamination removed from the sheet of rolled material of FIGS. 1A and 1B.

FIG. 3 depicts a diagram of an uninterruptible power supply system.

FIG. 4 depicts a diagram of an uninterruptible power supply system.

FIG. 5 depicts an exploded perspective view of an uninterruptible power supply system.

FIG. 6A depicts a top view of a sheet of rolled material having outlines of laminations thereon.

FIG. 6B depicts a side view of the sheet of rolled material shown in FIG. 6A.

FIG. 7 depicts a top detail view of the region labeled 7 shown in FIG. 6A.

FIG. 8A depicts a top view of a lamination usable within the scope of the present disclosure.

FIG. 8B depicts a perspective view of the lamination shown in FIG. 8A.

FIG. 8C depicts a side, cross-sectional view of the lamination shown in FIGS. 8A and 8B.

FIG. 9A depicts an exploded perspective view of a stacked pair of laminations usable within the scope of the present disclosure.

FIG. 9B depicts a diagrammatic side view of the stacked pair of laminations shown in FIG. 9A.

FIG. 10 depicts a diagrammatic exploded perspective view of two stacked pairs of laminations usable within the scope of the present disclosure.

FIG. 11A depicts a diagrammatic top view of an embodiment of a lamination usable within the scope of the present disclosure.

FIG. 11B depicts a diagrammatic top view of an embodiment of a lamination usable within the scope of the present disclosure.

FIG. 12A depicts an exploded perspective view of a rotor usable within the scope of the present disclosure.

FIG. 12B depicts a perspective view of the rotor shown in FIG. 12A.

FIG. 12C depicts a top view of the rotor shown in FIGS. 12A and 12B.

FIG. 12D depicts a side, cross-sectional view of the rotor shown in FIGS. 12A-12C.

FIG. 13 depicts an exploded perspective view of an embodiment of an alternator usable within the scope of the present disclosure.

FIG. 14 depicts a side, cross-sectional view of an embodiment of a rotor usable within the scope of the present disclosure.

FIG. 15A depicts a perspective view of an embodiment of a fastener usable within the scope of the present disclosure.

FIG. 15B depicts an end, cross-sectional view of the fastener shown in FIG. 15A.

FIG. 15C depicts a perspective view of an embodiment of a fastener usable within the scope of the present disclosure.

FIG. 15D depicts a perspective view of an embodiment of a fastener usable within the scope of the present disclosure.

FIG. 15E depicts a perspective view of an embodiment of a fastener usable within the scope of the present disclosure.

FIG. 16 depicts a diagrammatic top view of an embodiment of a rotor usable within the scope of the present disclosure.

FIG. 17A depicts a top, cross-sectional view of an embodiment of a fastener usable within the scope of the present disclosure.

FIG. 17B depicts a top, cross-sectional view of an embodiment of a fastener usable within the scope of the present disclosure.

FIG. 17C depicts a top, cross-sectional view of an embodiment of a fastener usable within the scope of the present disclosure.

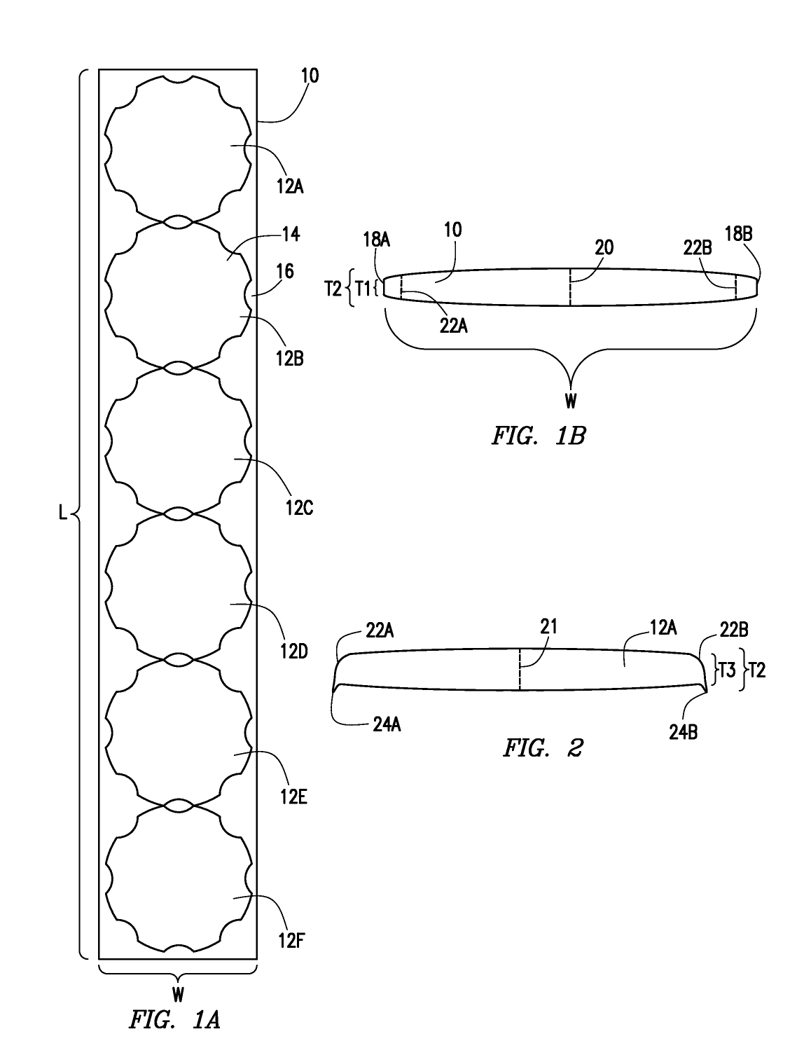

Like reference numbers in the various drawings indicate like elements.

### DETAILED DESCRIPTION OF ILLUSTRATIVE EMBODIMENTS

While embodiments usable within the scope of the present disclosure are described with reference to laminated rotor assemblies usable in a homopolar alternator, such as those described in U.S. Pat. Nos. 5,969,497 and 5,929,548, incorporated by reference above, it should be understood that embodiments usable within the scope of the present disclosure can be used in conjunction with any type of rotating machine, or any other type of device that includes one or more parts formed using laminated technology.

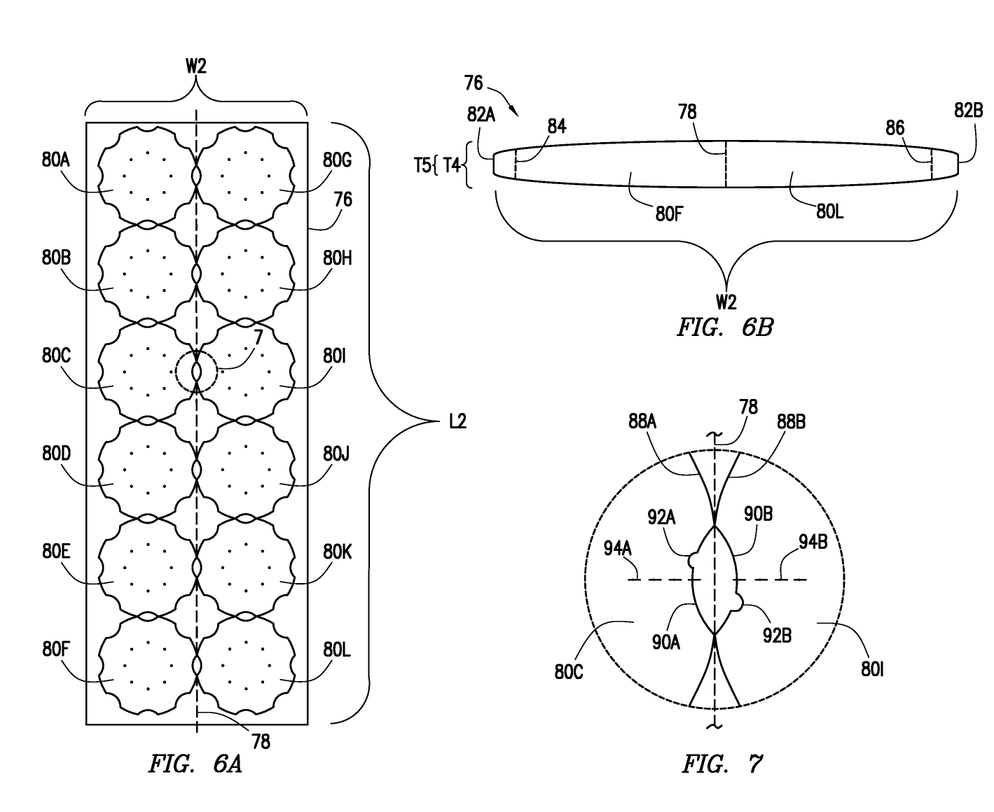

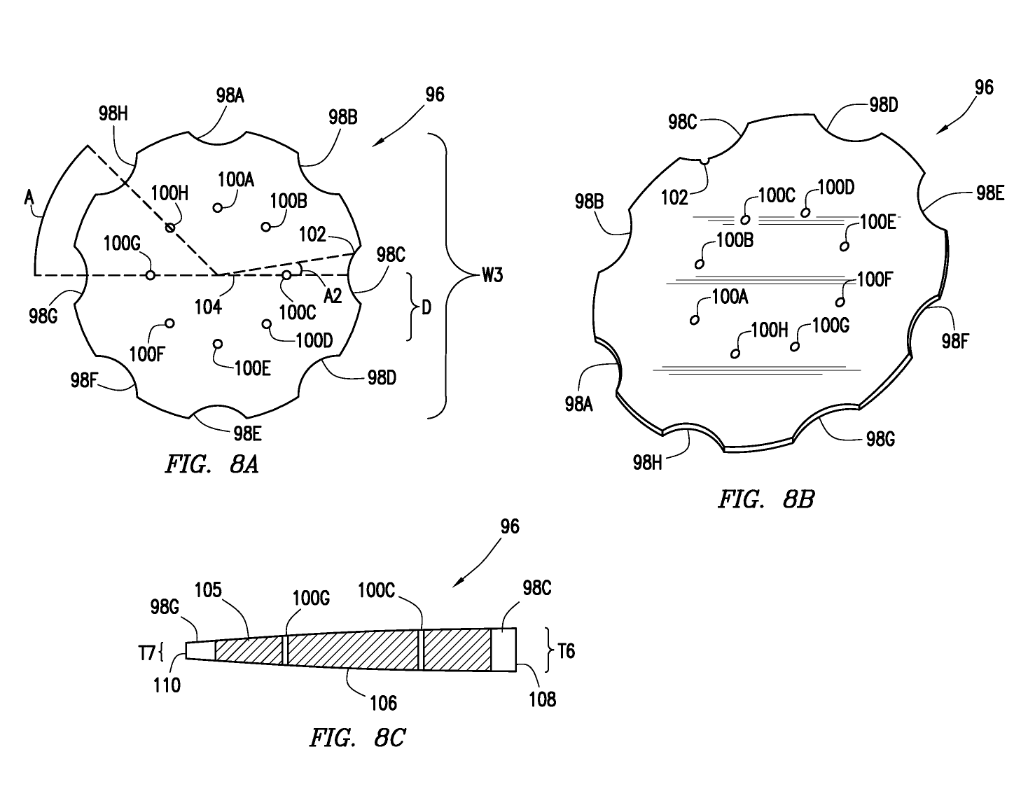

FIG. 6A depicts a top view of sheet of rolled, magnetically permeable material (76) (e.g., magnetic steel or a similar material), having a width (W2) and length (L2). FIG. 6B depicts a side view thereof. As described above, the sheet (76) can have a variable thickness, as illustrated in FIG. 6B, which depicts the sheet (76) having a thickness (T4) at the centerline (78) thereof greater than the thickness (T5) at the outer edges (82A, 82B). The outlines of twelve laminations (80A, 80B, 80C, 80D, 80E, 80F, 80G, 80H, 80I, 80J, 80K, 80L) are shown, each lamination outline abutting each adjacent outline without overlapping the adjacent outline. The outlines are shown oriented in a first row of six laminations (80A-80F) positioned on a first side of the centerline (78), and a second row of six laminations (80G-80L) positioned on a second side of the centerline (78) opposite the first, such that each lamination is disposed opposite another lamination, and the opposed laminations are an equal distance from the centerline (78). For example, FIG. 6A depicts each lamination (80A-80L) generally abutting the centerline (78) without overlapping it, while being spaced a distance from the edges (82A, 82B) of the sheet (76). FIG. 6B depicts the outer edge (84) of the sixth lamination (80F) and the outer edge (86) of the twelfth lamination (80L) positioned slightly inward from the edges (82A, 82B) of the sheet (76). The inner edges of the laminations (80F, 80L), while not separately labeled, can be at or proximate to the centerline (78). Placement of each of the lamination outlines (80A-80L) a generally equal distance from the centerline (78), oriented in the same direction, can enable each lamination removed from the sheet (76) to be generally identical.

FIG. 7 depicts a top detail view of the region (7) shown in FIG. 6A, showing the outer edge (88A) of the third lamination (80C) and the outer edge (88B) of the ninth lamination (80I) generally abutting one another and the centerline (78) of the sheet of material, without overlapping one another. The depicted region of the laminations (80C, 80I) includes arcuate notches (90A, 90B) disposed in opposition to one another relative to the centerline (78). A secondary notch (92A), usable as a visible indicator, is shown positioned within the arcuate notch (90A) of the third lamination (80C), and a similar secondary notch (92B) is shown positioned within the arcuate notch (90B) of the ninth lamination (80I). Both of the secondary notches (92A, 92B) can be offset a generally equal angular distance from the centerlines (94A, 94B) of the respective laminations (80C, 80I) within which they are formed.

FIGS. 8A, 8B, and 8C depict an exemplary lamination (96) usable within the scope of the present disclosure, identical or similar to any of the laminations removable from the sheet of material shown in FIGS. 6A, 6B, and 7. Specifically, FIG. 8A depicts a top view of the lamination (96), FIG. 8B depicts a perspective view thereof, and FIG. 8C depicts a side, cross-sectional view thereof.

The lamination (96) is shown having a generally round and/or circular body, with a diameter and/or width (W3), generally less than or equal to that of the sheet of material from which the lamination (96) can be removed. For example, an embodied lamination could have a diameter of approximately 25.48 inches (64.7 cm). Eight arcuate notches (98A, 98B, 98C, 98D, 98E, 98F, 98G, 98H) are shown formed in the perimeter of the lamination (96). The regions between the notches (98A-98H) can be used, for example, as rotor poles, in the manner described in U.S. Pat. Nos. 5,969,497 and 5,929,548, incorporated by reference above. The notches (98A-98H) are shown being generally symmetrical relative to a radius and/or centerline of the lamination (96). Eight orifices (100A, 100B, 100C, 100D, 100E, 100F, 100G, 100H) are shown formed through the body of the lamination (96), each orifice being spaced a distance (D) from the center of the lamination (96). For example, in an embodied lamination, the orifices (100A-100H) could be spaced about 11.26 inches (28.6 cm) from the center of the lamination (96). As described above, the orifices (100A-100H) can be used for accommodation of fasteners (e.g., studs) to secure multiple laminations together, e.g., to form a rotor. Placement of the orifices (100A-100H) a distance (D) from the center of the lamination (96) prevents the generation of stresses in the lamination (96) that can be created if an orifice is formed in the center thereof and/or a fastener is engaged at and/or through the center.

Each notch (98A-98H) and each orifice (100A-100H) is shown spaced a generally equal angular distance (A) from each adjacent notch and/or orifice. For example, an embodied lamination could have notches and orifices spaced 45 degrees from each adjacent notch and/or orifice. While FIGS. 8A and 8B depict each orifice (100A-100H) aligned, generally, with a respective notch (98A-98H), it should be understood that in various embodiments, the orifices and notches can be offset from one another.

In an embodiment, a lamination can have a generally nominal thickness, such as 0.125 inches, such that variations in thickness along the width of a lamination may be difficult to detect unaided. The stacking of laminations without regard to variations in thickness, however, can result in the formation of an unbalanced rotor and/or a rotor having non-uniformity in its overall height across its width. A secondary notch (102) is shown formed within the third arcuate notch (98C), and is usable as a visible indicator such that the thickest region of the lamination (96) can be readily identified upon visual inspection. For example, as shown in FIG. 8C, a first end (108) of the lamination (96) (e.g., the portion that would be proximate to the centerline of a sheet of material prior to removal of the lamination, similar to the configuration of lamination outlines on a sheet of material, shown in FIG. 6A), having the third arcuate notch (98C) formed thereon, is shown having a thickness (T6) greater than the thickness (T7) of the lamination (96) at a second, opposing end (110) thereof. The presence of the secondary notch (102) at the first end (108) thereby enables ready visual identification of the thickest portion of the lamination (96). It should be understood that while FIGS. 8A-8C depict the visible indicator (102) positioned proximate to the thickest portion of the lamination (96), in various embodiments, a visible identifier could be used to mark the thinnest region of a lamination and/or an intermediate region thereof.

As depicted in FIG. 8A, the secondary notch (102) is shown angularly offset from the centerline (104) of the lamination (96) by a selected angle (A2), e.g., to facilitate visible identification of the top face (105) and bottom face (106) of the lamination (96). For example, because the secondary notch (102) is shown offset in a counter-clockwise direction from the centerline (104), relative to the center of the lamination (96), when the lamination (96) is viewed from the top, the top face (105) (and the bottom face (106)) can be readily identified via visual inspection due to the position of the secondary notch (102). It should be understood that while FIGS. 8A-8C depict a single visible feature, the secondary notch (102), usable both to determine the thickest and thinnest regions of the lamination (96) and to identify the top and bottom faces (105, 106), separate visible indicators could be used to facilitate identification of different portions of laminations. Additionally, it should be understood that a secondary notch is only a single, exemplary embodiment of a usable visible indicator, and that any type of visible feature could be used to indicate selected portions of a lamination without departing from the scope of the present disclosure.

For example, FIG. 11A depicts a diagrammatic top view of an embodiment of a lamination (136) having an asymmetrical notch (138) formed in the periphery thereof. The location of the notch (138) can be used to identify the thickest and/or thinnest regions of the lamination (136), while the shape thereof can be used to identify the top and bottom faces of the lamination (136). FIG. 11B depicts a diagrammatic top view of an embodiment of a lamination (140) having an alignment notch (142) (e.g., a triangular slot) and/or protrusion formed therein. The position of the notch (142) can facilitate identification of the thicker and thinner regions of the lamination (140), and the presence or absence of the notch (142) on either face of the lamination (140) can facilitate identification of the top and bottom faces thereof. From the illustrative examples above, it should be understood that any manner of visible indicator and/or alignment feature can be incorporated without departing from the scope of the present disclosure.

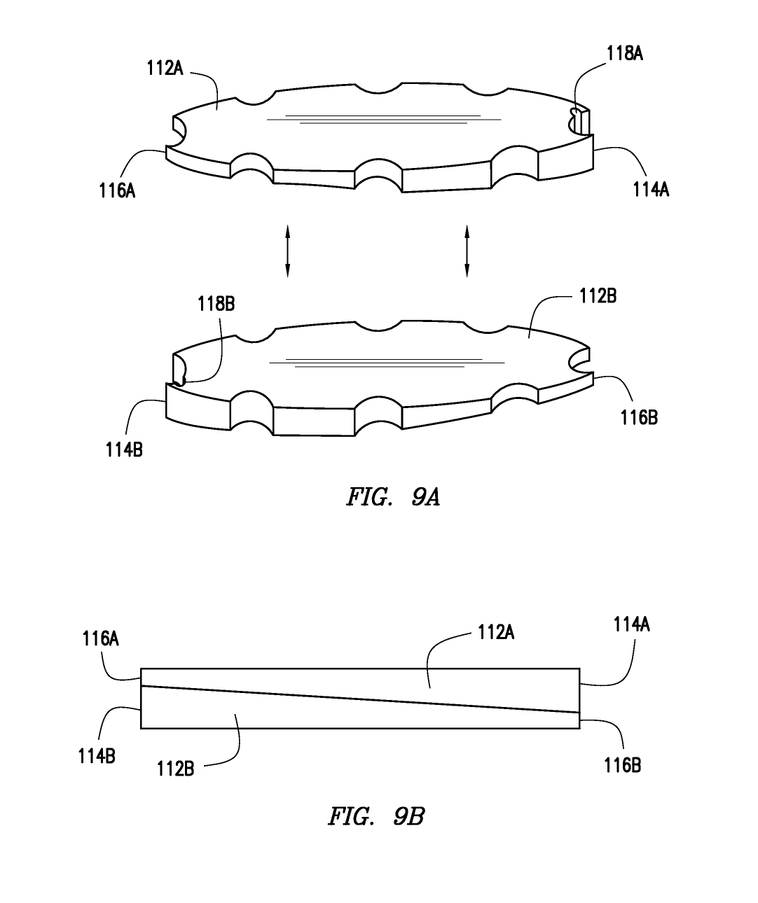

FIGS. 9A and 9B depict the assembly of a stacked pair of laminations. Specifically, FIG. 9A depicts an exploded view, showing two substantially identical laminations (112A, 112B), which can be produced via removal from a sheet of material, such as that depicted in FIG. 6A. Each lamination (112A, 112B) is shown having a generally circular body with eight arcuate notches formed in the periphery thereof, as described above with reference to FIGS. 8A and 8B. The first lamination (112A) is shown having a first, thicker region (114A) opposite a second, thinner region (116A), with a secondary notch (118A) serving as a visible indicator positioned at or proximate to the thicker region (114A). Similarly, the second lamination (112B) is shown having a thicker region (114B) opposite a thinner region (116B), with a secondary notch (118B) positioned at or proximate to the thicker region (114B). The laminations (112A, 112B) are shown positioned in opposing orientations relative to one another, such that each thicker region (114A, 114B) of a lamination (112A, 112B) is vertically aligned with the thinner region (116A, 116B) of the opposing lamination. Because small variations in thickness across the width of the laminations may be difficult to detect unaided, the presence of the visible indicators enables the laminations to be positioned in the depicted orientation by placing the secondary notches (118A, 118B) in an opposing orientation relative to one another.

FIG. 9B depicts a diagrammatic side view of an assembled stacked pair of laminations, showing the thicker region (114A) of the first lamination (112A) in vertical alignment with and contacting the thinner region (116B) of the second lamination (112B), and the thinner region (116A) of the first lamination (112A) in vertical alignment with and contacting the thicker region (114B) of the second lamination (112B).

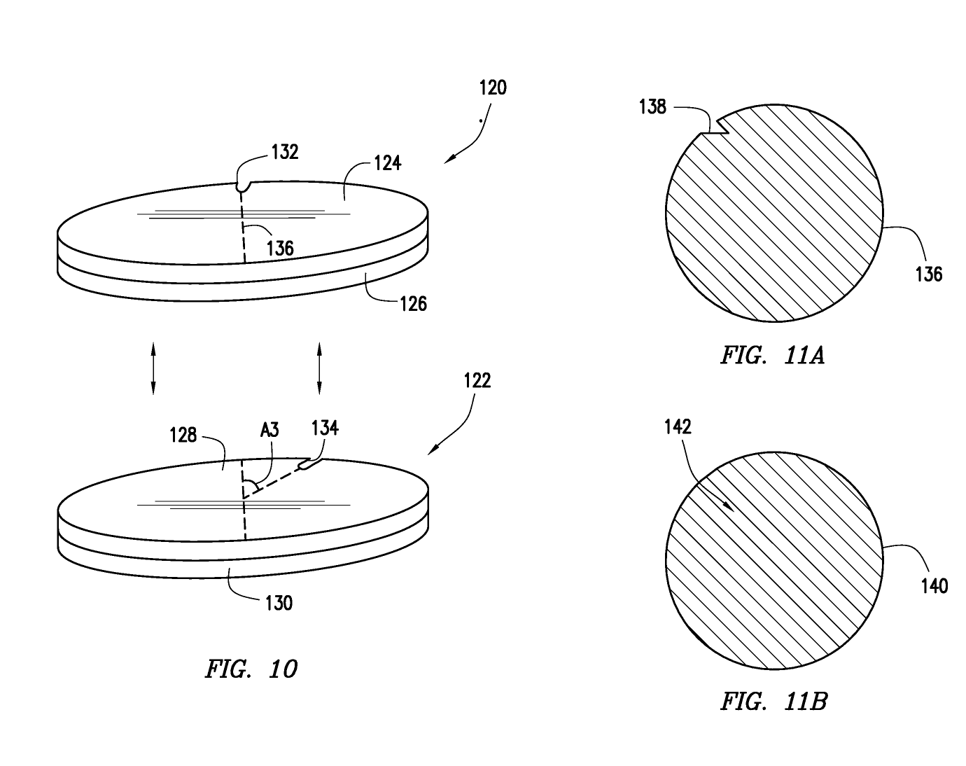

As described above, multiple stacked pairs of laminations, such as that depicted in FIGS. 9A and 9B, can be stacked and/or otherwise placed in association with one another to form a rotor. For example, FIG. 10 depicts an diagrammatic exploded perspective view of a first stacked pair of laminations (120) vertically aligned with a second stacked pair of laminations (122). The first stacked pair (120) can be formed by arranging two laminations (124, 126) in the manner described previously. Similarly, the second stacked pair (122) is shown including two laminations (128, 130). While arcuate notches, orifices, and other features that may be present in the laminations (124, 126, 128, 130) have been omitted for clarity, FIG. 10 depicts a visible indicator (132), shown as a notch, formed on the first stacked pair (120), and a second visible indicator (134) formed in the second stacked pair (122). While embodiments used within the scope of the present disclosure can include use of laminations that are generally identical to one another, which would subsequently form stacked pairs of laminations that are generally identical, slight variations in laminations and/or pairs thereof may exist, e.g., due to small variations in the thickness of a sheet of material along its length. To account for the possibility of such variations, multiple stacked pairs of laminations can be offset from one another. For example, in an embodiment, each successive stacked pair of laminations can be rotationally offset by a known angle relative to each adjacent pair. Visible indicators in the laminations can be used to facilitate orienting stacked pairs in this manner by allowing corresponding locations of each stacked pair to be readily identified via visual inspection. FIG. 10 depicts the visible indicator (134) of the second stacked pair (122) rotationally offset by an angular distance (A3) from the centerline (136) of the first stacked pair (120), which extends coincident with the first visible indicator (132). The angular distance (A3) can be generally equal to the angle between successive arcuate notches, such that the notches and orifices each stacked pair of laminations align with notches and orifices in each successive stacked pair. For example, in an embodiment, the angular distance (A3) can be an integer multiple of 360 divided by the number of notches in each lamination. For a lamination having 8 notches, the angular distance (A3) could be any multiple of 45 degrees. (N*360/8=N*45, where N is an integer).

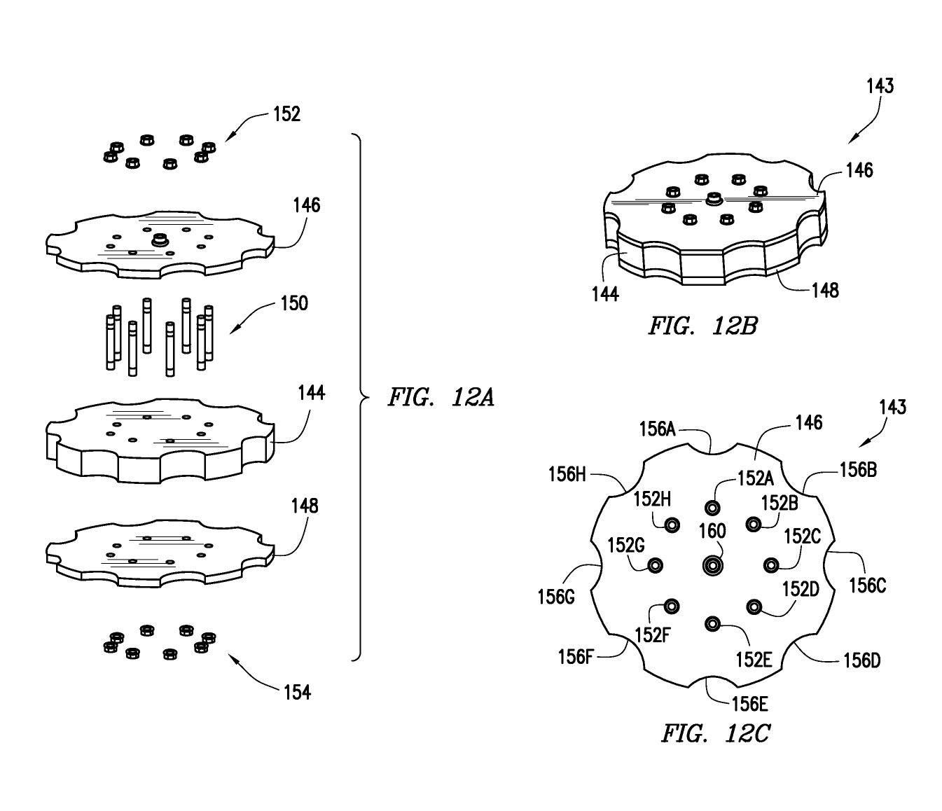

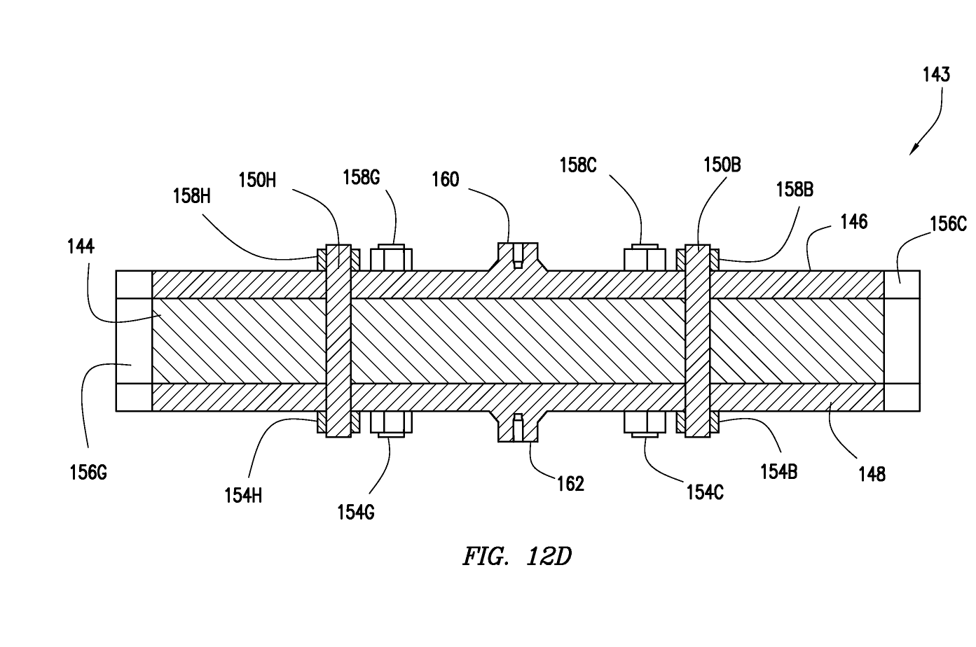

FIGS. 12A, 12B, 12C, and 12D depict a rotor (143) usable within the scope of the present disclosure, that can be formed using lamination technology. Specifically, a plurality of laminations can be arranged in stacked pairs, as described above, and a plurality of stacked pairs can be placed in vertical alignment with one another, then compressively retained in association with one another, e.g., through the attachment of plates on opposing sides of the stacked pairs of laminations.

FIG. 12B depicts a perspective view of the rotor (143), which includes a laminate core (144) secured between an upper plate (146) and a lower plate (148). The plates (146, 148) can be used to compressively retain the laminations that form the core (144) (e.g., such that relative movement of laminations relative to one another is restricted), while providing rigidity to the rotor (143), and also providing a location to which rotational bearings and/or other external structures can attach without interfering with the structure of the laminations. FIG. 12A depicts an exploded perspective view, illustrating the use of fasteners (150) (e.g., studs) that can be provided through the aligned orifices within the laminations that form the core (144), and engaged with similar orifices in the plates (146, 148). In an embodiment, the fasteners (150) can be adapted to engage the plates (146, 148) via an interference fit, while the orifices within the laminations that form the core (144) can be sized to provide a sufficient clearance between the fasteners (150) and the laminations, such that the fasteners (150) do not contact the laminations during rotation of the rotor (143). A first set of nuts (152) is shown, usable to engage the upper threaded ends of the fasteners (150), e.g., to limit movement of the fasteners (150). Similarly, a second set of nuts (154) can be used to engage the lower threaded ends of the fasteners (150).

FIG. 12C depicts a top view of the rotor (143), illustrating the top plate (146) having a plurality of arcuate notches (156A, 156B, 156C, 156D, 156E, 156F, 156G, 156H) in vertical alignment with notches in the laminations that form the core, and similar notches in the bottom plate, such that the regions between the aligned notches (156A-156H) can function as rotor poles, e.g., in the manner described in U.S. Pat. Nos. 5,969,497 and 5,929,548, incorporated by reference above. Each of the first set of nuts (152A, 152B, 152C, 152D, 152E, 152F, 152G, 152H) is shown spaced a generally equal distance from the center of the rotor (143) and top plate (146). Placement of orifices within the laminations to accommodate passage of the fasteners in a location offset from the center thereof reduces the formation of stresses on the laminations and rotor (143). The top plate (146) is further shown having an attachment point (160) (e.g., a shaft) usable for engagement with a bearing structure and/or other components for enabling relative movement of the rotor (143) relative to other portions of the device of which the rotor is a part (e.g., a flywheel alternator or similar apparatus).

FIG. 12D depicts a side, cross-sectional view of the rotor (143), in which the laminate core (144) is shown compressively retained between the top and bottom plates (146, 148). Two of the arcuate notches (156G, 156C) are visible at the periphery of the rotor (143), while four upper nuts (158H, 158G, 158C, 158B) and four lower nuts (154H, 154G, 154C, 154B) are visible in this view, for retaining fasteners into engagement with the plates (146, 148). Two of the fasteners, (150H, 150B) are visible in the depicted view, extending through aligned orifices in the plates (146, 148) and similar orifices in the laminate core (144). As described previously, in an embodiment, the fasteners and/or the orifices in the plates can be sized and/or shaped such that the fasteners engage the plates (146, 148), e.g., via an interference fit, while the fasteners and/or orifices in the laminations can be sized and/or shaped such that during rotation of the rotor (143), the fasteners do not significantly contact the laminations. FIG. 12D also illustrates upper and lower attachment points (160, 162), positioned at the approximate center of the top and bottom plates (146, 148), respectively, usable to engage the rotor (143) with adjacent components, such as bearings, to permit movement of the rotor relative to other portions of the device within which it is engaged.

It should be understood that the rotor depicted in FIGS. 12A-12D is a single exemplary embodiment, and that the methods and systems described herein can be applied to any type of rotating device. For example, in an embodiment, a shaft could be connected to a rotor core without the use of top and bottom plates. In various embodiments, the rotor core could be secured using any combination of fastening techniques, such as mechanical fasteners, welding, and/or adhesives. Rotors constructed using the configurations and methods described herein can be balanced about the center axes thereof, and exhibit uniform magnetic properties, while allowing for cost-effective methods of manufacture. Additionally, in machines in which a rotor is exposed to a time-varying magnetic field, use of laminations may reduce eddy current losses in the rotor when compared to conventional alternatives.

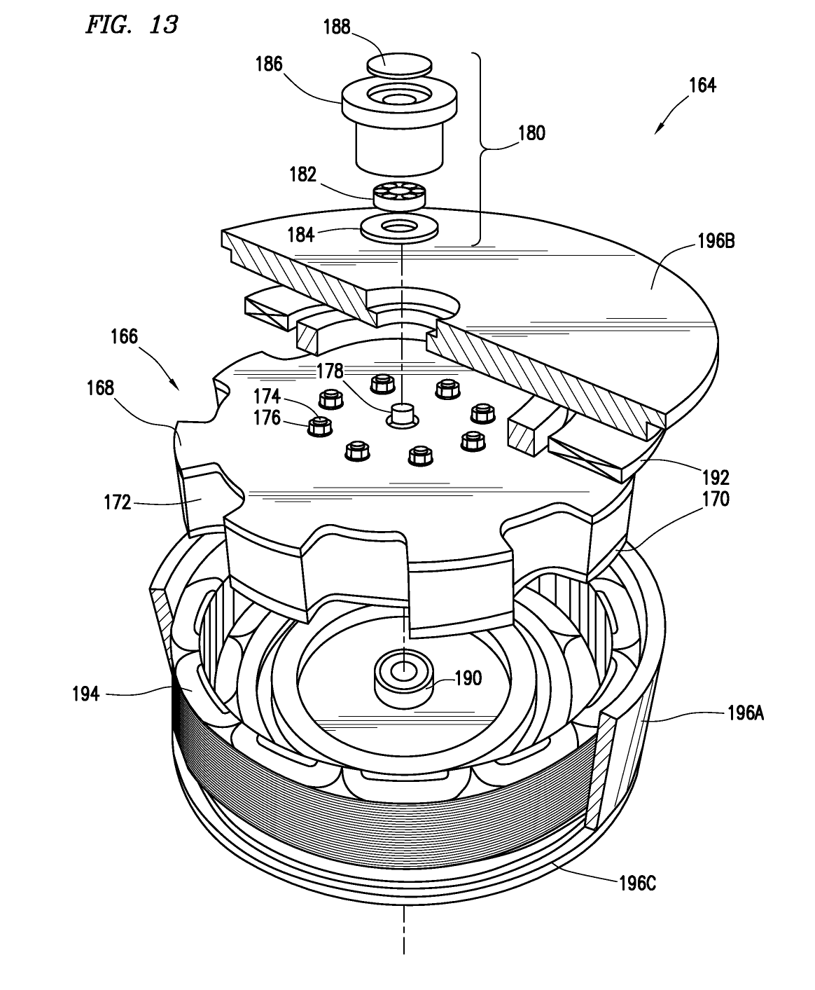

FIG. 13 depicts an exploded perspective view of an embodiment of a homopolar inductor-alternator device (164), similar to those described in U.S. Pat. Nos. 5,969,497 and 5,929,548, incorporated by reference above. The depicted device can include a laminated rotor (166), similar to that depicted in FIGS. 12A-12B, and/or made using any of the methods described above. The depicted rotor (166) includes a top plate (168), a bottom plate (170), and a laminated rotor core (172) compressively retained between the plates (168, 170). A set of mechanical connectors, specifically, eight studs, of which an exemplary stud (174) is labeled for reference, extend through aligned orifices in the plates (168, 170) and core (172), the studs being retained using nuts, of which an exemplary nut (176) is labeled for reference. An attachment point, depicted as a top shaft (178) is positioned at the center of the top plate (168) and is supported by a bearing cartridge (180). The depicted bearing cartridge (180) includes a bearing (182), a bushing (184), a housing (186), and an end cap (188). A bottom shaft (not visible in FIG. 13), positioned on the bottom plate (170) can similarly be supported by a bearing assembly, of which a bearing (190) is visible.

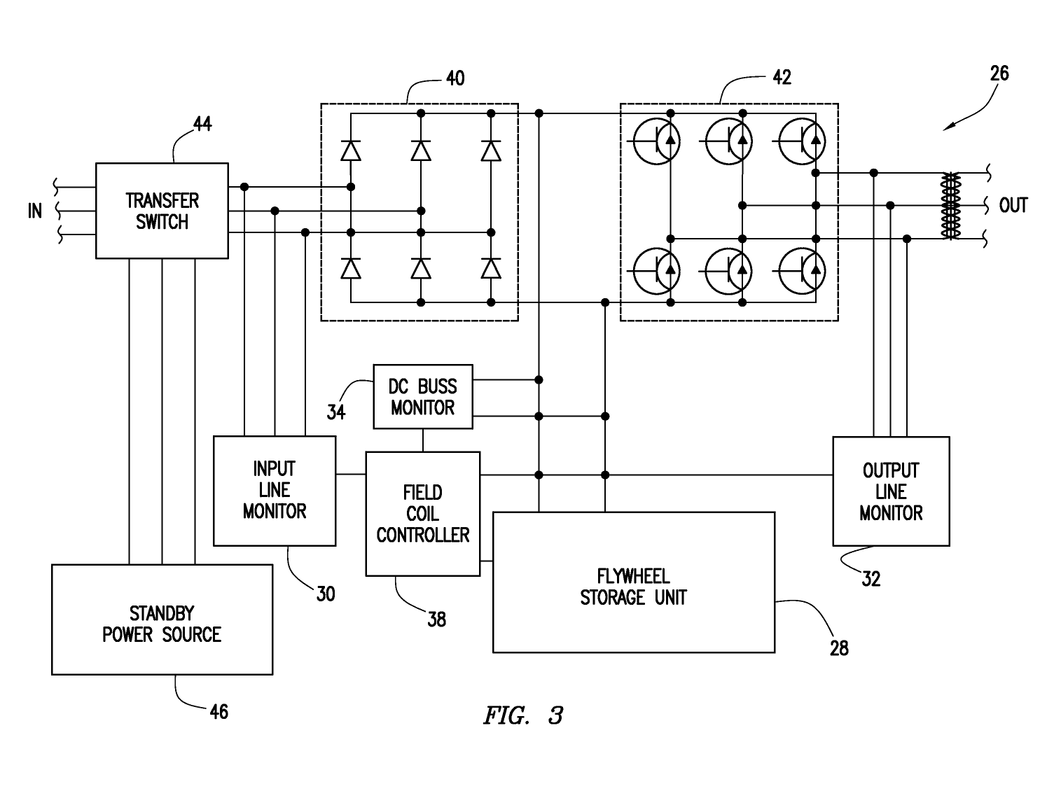

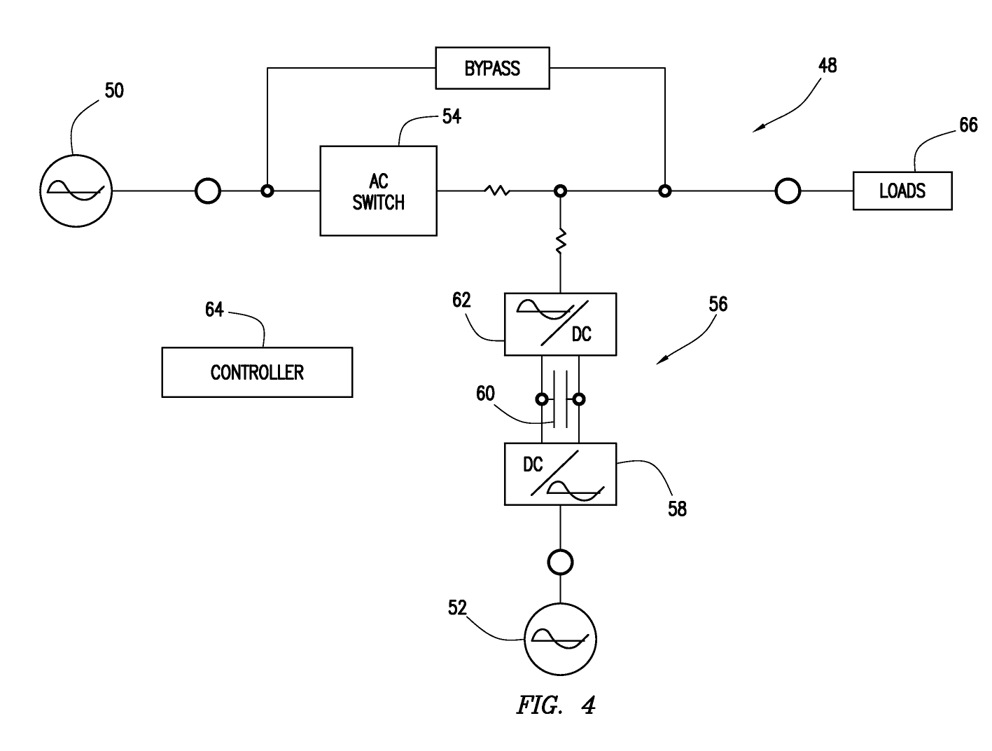

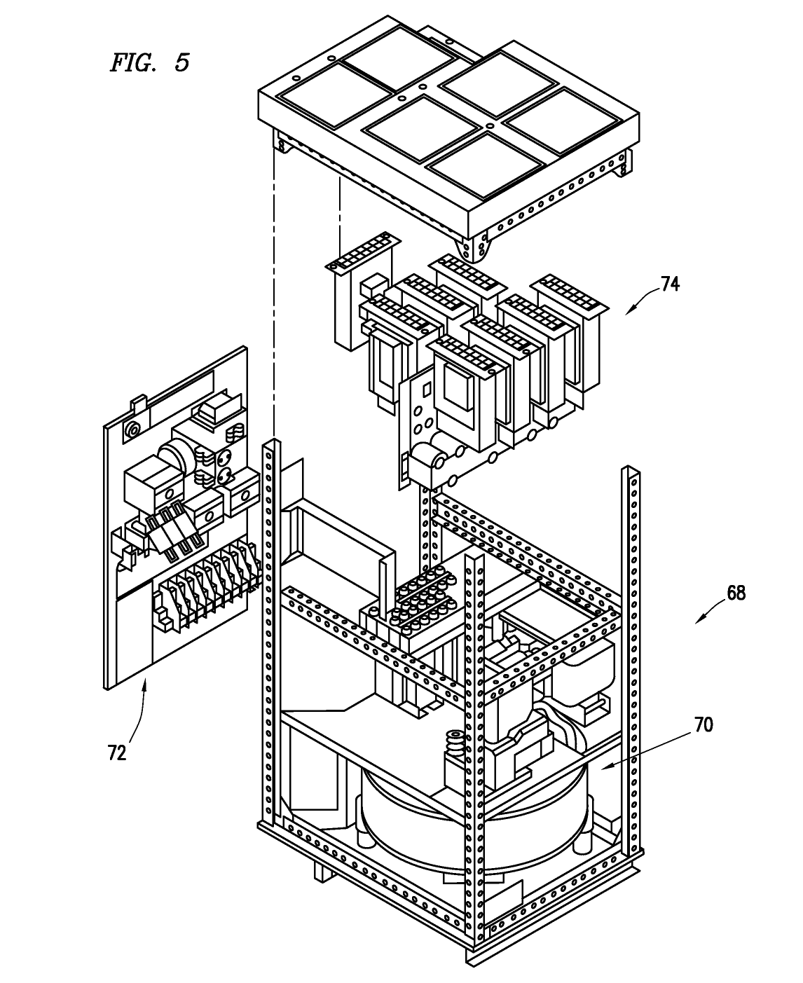

The depicted alternator device (164) includes a stationary field coil (192), armature coils (194), and permeable non-rotating members (196A, 196B, 196C) (e.g., portions of a housing), as well as other components, the operation of which is described in greater detail in U.S. Pat. No. 5,929,548, incorporated by reference above. Generally, in operation, current flowing in the field coil may generate a homopolar flux in a series magnetic circuit that includes the rotor, the permeable non-rotating members, and one or more gaps between the rotor and the non-rotating members. Rotation of the rotor can include alternating current voltage in the armature coils, which may be located in one of the gaps. Use of a laminated rotor (e.g., in lieu of a conventional solid/cast rotor) can allow for lower manufacturing costs of both the rotor and the alternating device, while allowing for rotation of the rotor at greater speeds. The advantages of a flywheel energy storage device incorporating one or more embodiments described herein can be incorporated into uninterruptible power systems, such as those depicted in FIGS. 3-5.

As such, flywheel energy storage apparatuses (e.g., homopolar flywheel alternators or similar devices) usable within the scope of the present disclosure can generally include a rotor (e.g., a laminated rotor produced as described above), and a controller for controlling power flow between a power source, the flywheel energy storage apparatus, and a load. The rotor can be permeable, forming part of a series magnetic circuit that includes: non-rotating permeable members (e.g., portions of an enclosure housing the rotor), a gap between the rotor and non-rotating members, a coil for inducing a flux in the series magnetic circuit (the magnitude of the flux varying as a function of the magnitude of the current in the coil), and at least one armature coil located in one or more of the gaps, the gaps and/or armature coil(s) arranged such that rotation of the rotor induces a voltage in the armature coil(s). An uninterruptible power supply system can incorporate such a flywheel apparatus and controller, e.g., within an enclosure, while a power source and/or a load are located external thereto. A UPS can include any number of additional power sources (e.g., a motor-generator set or similar device), and the controller can control power flow between each of the power sources, the load, and/or the flywheel energy storage device.

As described above, in a laminated rotor, fasteners (e.g., mechanical and/or axial fasteners) can be used to retain stacked laminations in contact with one another during rotation of the rotor. For example, an initial preload of a set of fasteners can be used to determine an initial uniform tensional stress in the fasteners, e.g., when the rotor is at rest. When the rotor is rotating, however, rotational forces can cause the diameter of the rotor to increase and the thickness thereof to decrease, thereby decreasing the tension of the in the fasteners from the initial value. Further, centrifugal forces can cause the fasteners to bend raidally outward, thereby increasing tensile stress on the outermost portions of the fasteners while reducing tensile stress on the innermost portions. As such, fasteners for retaining a laminated rotor must be designed in a manner that withstands expected tensile stresses, while retaining the laminations in contact with one another at the during rotation of the rotor at the maximum expected angular velocity.

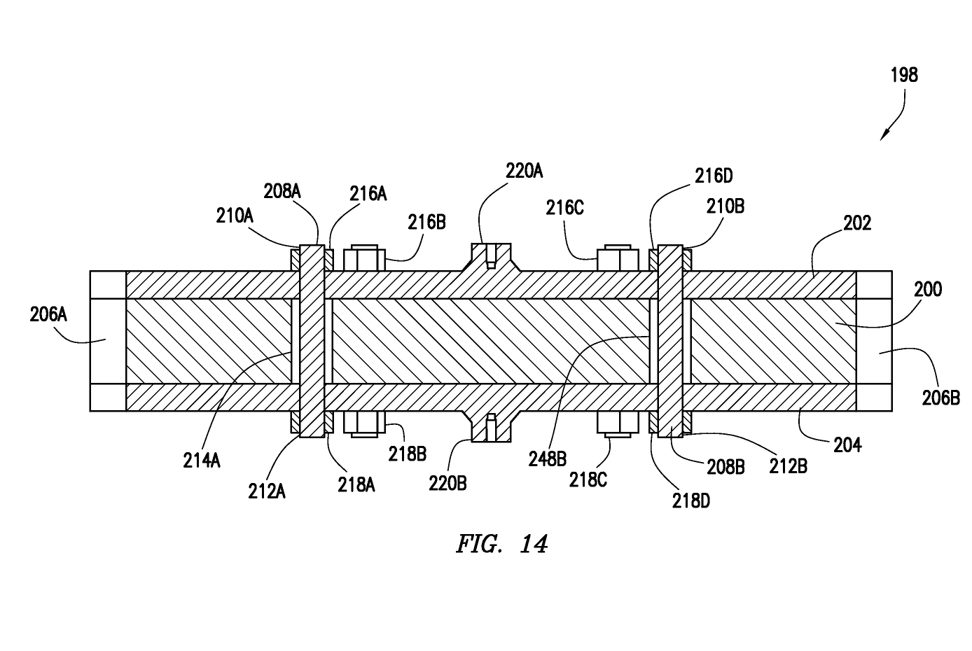

FIG. 14 depicts a side, cross-sectional view of an embodiment of a rotor (198) usable within the scope of the present disclosure. The depicted rotor (198) includes a laminate rotor core (200), which can be formed, for example, using the configurations and/or methods described previously, the laminations thereof being compressively retained in association with one another by a top plate (202) and a bottom plate (204), which can be constructed from high-strength material to maintain compression on the core (200) and resist deformation during rotation. The laminations of the core (200) and both plates (202, 204) can include arcuate notches (e.g., eight notches) formed in the periphery thereof, similar to the embodied rotors described previously, of which two notches (206A, 206B) are visible in FIG. 14.

Mechanical fasteners, such as studs, can be used to retain the plates (202, 204) in association with the core (200), while the studs can be tensioned and/or retained using nuts. The configuration of studs and associated nuts can be similar to the configuration depicted in the embodied rotors described previously (e.g., having eight studs extending through aligned orifices in each lamination and plate, each stud being tensioned using one nut at each end thereof). In the view depicted in FIG. 14, two studs (208A, 208B) are visible, each stud (208A, 208B) extending through an associated orifice (210A, 210B) in the top plate (202), and an associated orifice (212A, 212B) in the bottom plate (204). The studs (208A, 208B) each also pass through an associated clearance (214A, 214B) in the lamination core (200), which can be formed through the alignment of orifices in each lamination used to form the core (200). To maintain proper balance of the rotor (198), the relative positions of the studs (208A, 208B) can be maintained generally constant during rotation of the rotor (198). As such, in an embodiment, the studs (208A, 208B) can engage the top and bottom plates (202, 204) via an interference fit. For example, portions of the studs (208A, 208B) and/or the orifices (210A, 210B, 212A, 212B) in the plates (202, 204) can be sized to accommodate an interference fit between the studs (208A, 208B) and the plates (202, 204). To prevent degradation of the laminations and/or the fasteners, which can result in eventual failure of the fastener and/or rotor due to fatigue at the locations of contact, contact between the studs (208A, 208B) and the lamination core (200) can be minimized during rotation of the rotor (198). As such, in an embodiment, the diameter of the clearances (214A, 214B) and/or that of corresponding portions of the studs (208A, 208B) can be sized to provide a space between the studs (208A, 208B) and the core (200). For example, the diameter of the clearances (214A, 214B) can be larger than that of the orifices (210A, 210B, 212A, 212B) in the plates (202, 204), such that the studs (208A, 208B) can engage the plates (202, 204) (e.g., via an interference fit) while passing unimpeded through the laminations in the core (200). A plurality of upper nuts, of which four nuts (216A, 216B, 216C, 216D) are visible in FIG. 14, can be threaded to upper ends of associated studs and used to thread and/or further retain the studs. Similarly, a plurality of lower nuts, of which four nuts (218A, 218B, 218C, 218D) are visible in FIG. 14, can be threaded to the lower ends of associated studs. Upper and lower shafts (220A, 220B), extending from the top and bottom plates (202, 204), respectively, can be used to engage the rotor (198) with adjacent bearing assemblies and/or other components.

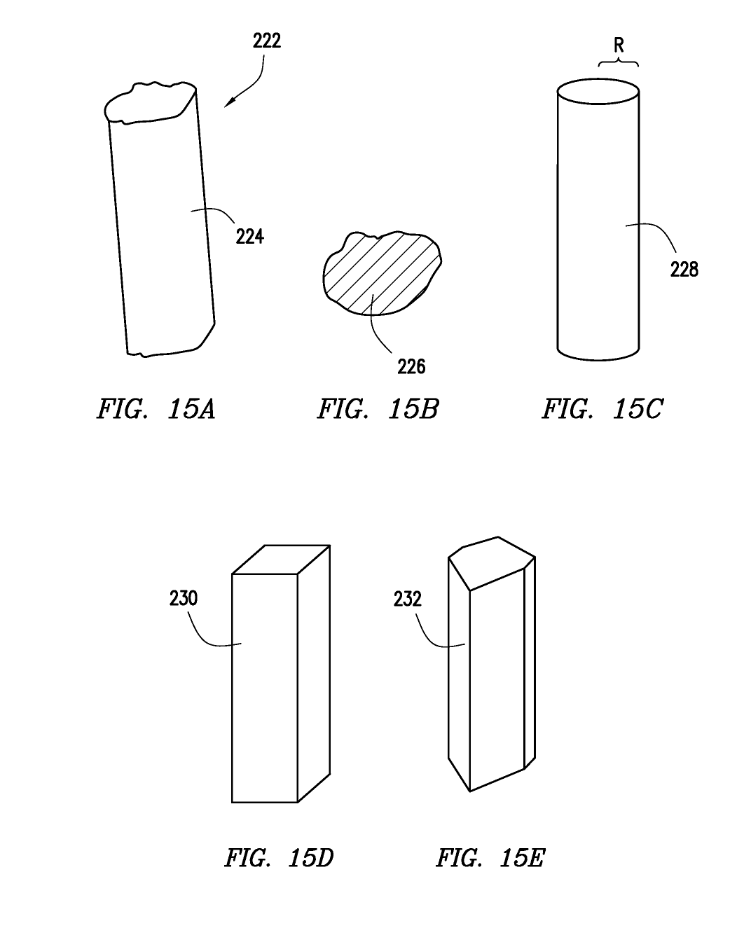

FIGS. 15A-15E depict embodiments of fasteners, such as studs, usable within the scope of the present disclosure. By way of example, a conventional fastener typically includes a solid body, as shown in FIG. 15A, which depicts a solid fastener (222), having a generally round body with a lateral surface geometry (224) and a cross-sectional area (226), depicted in FIG. 15B, that defines an envelope. FIG. 15C depicts a generally cylindrical fastener (228), having a generally uniform, circular cross-section with a radius (R). It should be understood that fasteners, and the envelopes defined by the cross-sectional areas thereof, can have any shape, including that of a regular prism, such as the fastener (230) depicted in FIG. 15D, or an irregular prism, such as the fastener (232) depicted in FIG. 15E. As used herein, fasteners share the same “envelope” if at least a portion of the lateral surface area of a fastener is contiguous with the lateral surface area of the envelope defined by another fastener; however, fasteners may vary with regard to the amount and distribution of material within an envelope.

As described above, for example, with regard to the rotors depicted in FIGS. 12A-12D and FIG. 14, fasteners can be spaced a selected distance from the center of a rotor, such that the fasteners experience non-concentric rotation during rotation of the rotor. During non-concentric rotation, a solid fastener will exhibit a maximum tensile bending stress (e.g., the portion of the total tensile stress that is caused by rotation of the fastener) along the outermost fibers of its lateral surface. This maximum tensile bending stress creates an upper limit for the angular velocity of the rotor. Embodiments usable within the scope of the present disclosure can include fasteners that are shaped in a manner that diminishes bending stresses. It is noted that modifications to the shape of a fastener may result in a fastener that is less stiff than conventional alternatives, and as such, embodiments usable within the scope of the present disclosure can be shaped in a manner that bending stresses experienced by a fastener are diminished to a greater extent than the stiffness of the fastener. Lower peak stress in a fastener at a given angular velocity of a rotor can allow higher rotor speeds, while the fasteners therein can retain sufficient strength to maintain a laminated rotor under compression.

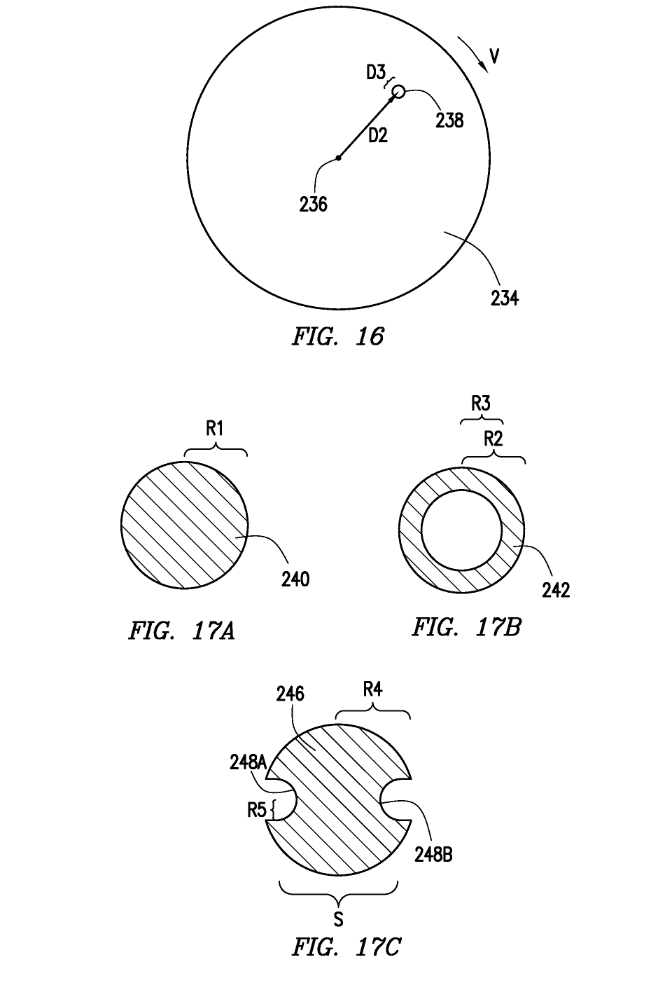

FIG. 16 illustrates this concept by depicting a diagrammatic top view of a rotor (234), shown having a generally round shape. It should be understood that rotors usable within the scope of the present disclosure can have any shape and features, and that the generally circular diagrammatic view shown in FIG. 16 is an exemplary conceptual drawing. The rotor (234) is shown having a center (236) and a fastener (238) positioned at a distance (D2) from the center (236), such that rotation of the rotor in the angular direction (V) imparts centrifugal forces to the fastener (238). While FIG. 16 depicts a single fastener (238) as an illustrative example, it should be understood that rotors usable within the scope of the present disclosure can include any number of fasteners, arranged and spaced in any manner.

The depicted fastener (238) occupies an envelope having a length generally equal to the height of the rotor (234) and/or the core thereof, and a maximum outside dimension generally equal to the diameter (D3) of the fastener (238) and/or the orifice within which the fastener (238) passes. As such, if the maximum dimension of the fastener across its cross-section lies along a radius of the rotor (234), the approximate peak tensile bending stress of the fastener would be:

$${σ}_{max} = ( \frac{{L}^{2} \cdot {R}_{o} \cdot ρ \cdot {ω}^{2}}{12} ) \cdot ( \frac{c \cdot A}{I} ) = ( k ) \cdot ( \frac{c \cdot A}{I} )$$

In the above equation, L is the length of the fastener, Ro is the distance between the center of the fastener and the center of rotation (e.g., the center of the rotor), ρ is the mass density of the fastener, ω is the angular velocity of the rotor, c is the distance from the outer surface of the fastener to the neutral axis thereof (the center of the fastener along the radius of the rotor−c=D/2), A is the cross-sectional area of the fastener, and I is the area moment of inertia of the fastener. As such, the above equation is formed of two factors, each enclosed in a respective set of parentheses: the first factor is substantially constant for a given set of operating conditions, a given fastener material and a given fastener envelope, and is denoted on the right side of the equation by the constant k. The second factor is a function of the shape of the fastener within the envelope, e.g., the amount of material and the distribution of material within the envelope.

By way of example, FIG. 17A depicts a top, cross-sectional view of a fastener (240) having a generally cylindrical shape (e.g., a circular cross-sectional are), with a radius (R1). The depicted fastener (240) is a generally solid body. FIG. 17B depicts a top, cross-sectional view of a fastener (242) having an annular cylindrical shape, e.g., a cylindrical sleeve body with a longitudinal bore extending therethrough. As such, the fastener (242) has an outer radius (R2), while the bore therein has an inner radius (R3). In the example illustrated by FIGS. 17A and 17B, if the depicted fasteners (240, 242) have the same length and are made from the same material (e.g., high strength steel), having the same mass-per-unit volume (e.g., density), and are positioned the same distance from the center of rotation of a rotor (e.g., at the location of the fastener depicted in FIG. 16), each of the fasteners (240, 242) will exhibit different peak bending stresses.

The cross-sectional area (A) and moment of inertia (I) for the solid fastener (240), depicted in FIG. 17A, can be calculated using the following equations:

$$A = π \cdot ( {r}_{o}^{2} )$$

$$I = \frac{π}{4} \cdot {r}_{o}^{4}$$

As described above, the peak bending stress can be calculated using the following equation:

$${σ}_{max} = ( \frac{{L}^{2} \cdot {R}_{o} \cdot ρ \cdot {ω}^{2}}{12} ) \cdot ( \frac{c \cdot A}{I} ) = ( k ) \cdot ( \frac{c \cdot A}{I} )$$

By substituting the outer radius Ro (depicted as R1 in FIG. 17A) of the fastener (240) for c, the peak bending stress can be calculated using the following equation:

$${σ}_{max} = k \cdot \frac{4}{{r}_{o}}$$

The cross-sectional area and moment of inertia for the annular fastener (242), depicted in FIG. 17B, can be calculated using the following equations:

$$A = π \cdot ( {r}_{o}^{2} - {r}_{i}^{2} )$$

$$I = \frac{π}{4} \cdot ( {r}_{o}^{4} - {r}_{i}^{4} )$$

As such, the peak bending stress for the annular fastener (242) can be calculated by the following equation:

$${σ}_{max} = k \cdot \frac{4 \cdot {r}_{o}}{( {r}_{o}^{2} + {r}_{i}^{2} )}$$

The equations used to calculate the peak bending stresses of the solid and annular fasteners (240, 242) illustrate that the peak bending stress in a fastener occupying a cylindrical envelope can be reduced by removing material from within the envelope. As the inner radius (e.g., radius (R3) shown in FIG. 17B) of the region from which material is removed (e.g., the longitudinal bore shown in FIG. 17B) increases, the mass of the fastener decreases, as does its maximum bending stress. As the inner radius approaches the outer radius, the stress in the annular fastener (242) tends toward a value that is one-half that for the solid fastener (240). As the wall of the annular fastener (242) is thinned, however, the stiffness of the fastener decreases. As such, a sufficient quantity of material can be retained to enable the fastener to withstand the axial tension required to maintain the laminations in compression.

In one example, FEA analysis was performed on three fasteners, all sharing the same cylindrical envelope having dimensions L=5 inches and rₒ=0.375 inches; all made of a material having a density of 0.283 pounds-per-cubic-inch; and all rotating at an angular velocity ω=7700 RPM at a distance from the center of rotation of Rₒ=5.63 inches. A solid fastener has A=0.442 in²; I=0.016 in⁴; and σₘₐₓ=59.6 kilopound/in². An annular fastener with rᵢ=0.1875 inch has A=0.331 in²; I=0.015 in⁴; and σₘₐₓ=47.7 kilopound/in². An annular fastener with rᵢ=0.25 inch has A=0.245 in²; I=0.012 in⁴; and σₘₐₓ=41.3 kilopound/in².

FIG. 17C depicts an embodiment of a fastener (246) having an “I-beam” configuration, in which two curved regions (248A, 248B) have been formed at the periphery thereof, e.g., to reduce the total quantity of material within the envelope occupied by the fastener (246). The fastener (246) has a radius (R4), and each of the curved regions (248A, 248B) has a radius (R5). The center of each curved region is spaced a distance (S) from that of the other curved region. In another example, FEA analysis was performed on two “circular I-beam” fasteners having the configuration shown in FIG. 17C, each fastener sharing the same cylindrical envelope, material characteristics and operating conditions described with reference to the fasteners shown in FIGS. 17A and 17B (L=5 inches, rₒ=0.375 inches; material density=0.283 pounds-per-cubic-inch; ω=7700 RPM; Rₒ=5.63 inches). The radius (R5) for each measured fastener was 0.1875 inches, and the spacing (S) was 0.71 inches. As such, A=0.327 in²; I=0.0146 in⁴; and σₘₐₓ=46.6 kilopound/in². For a spacing (S) of 0.51 inches, A=0.2525 in²; I=0.0138 in⁴; and σₘₐₓ=38.3 kilopound/in².

As illustrated and described above, a fastener can be advantageously designed by shaping the fastener to reduce peak centrifugal stresses thereon while retaining sufficient stiffness to maintain intimate contact between laminations under peak tensile stress loading. In an embodiment, selection of shape and dimensions of the envelope and achieving a reduction of mass within the envelope, cylindrical or otherwise, to reduce maximum bending stress while maintaining sufficient strength, can be accomplished using closed-form analysis and/or FEA.

While the above embodiments describe fasteners having a uniform cross section along the entire length thereof, in various embodiments, usable fasteners could have sections characterized by differing geometries. For example, a fastener can have a central section shaped to reduce bending stresses, while sections at the ends thereof can be sized to fit closely within regions in the top and bottom plates of a rotor, while the ends can be sized to accommodate a threaded nut. In practice, a fastener can include multiple shaped regions having the same or differing cross-sectional shapes and/or areas, and the same or different envelopes. In some embodiments, a rotor core can be formed with two or more stacks of laminations, with a central plate positioned between the stacks. In such embodiments, fasteners can extend from the top plate to the interior plate, while other fasteners extend from the interior plate to the bottom plate. Each of such fasteners can be shaped to reduce bending stresses while having sections designed to fit closely within the top, bottom, and/or interior plates.

It will be understood that various modifications may be made to the disclosed subject matters described herein without departing from the spirit and scope of the disclosed subject matter. The present technical disclosure includes the above embodiments which are provided for descriptive purposes. However, various aspects and components of the disclosed subject matter provided herein may be combined and altered in numerous ways not explicitly described herein without departing from the scope of the disclosed subject matter, which the following claims particularly call out as novel and non-obviousness elements.

What is claimed is:

1. A rotor apparatus comprising:
a plurality of laminations comprising a center and at least one orifice spaced a distance from the center; and
at least one fastener extending through said at least one orifice, wherein said at least one fastener, said at least one orifice, or combinations thereof are sized to reduce contact between said at least one fastener and the plurality of laminations during rotation of the rotor apparatus.

2. The rotor apparatus of claim 1, further comprising a first plate positioned in contact with a first side of the plurality of laminations and a second plate positioned in contact with a second side of the plurality of laminations, wherein said at least one fastener engages a first opening in the first plate and a second opening in the second plate to compressively retain the plurality of laminations.

3. The rotor apparatus of claim 2, wherein said at least one fastener, the first opening, the second opening, or combinations thereof is sized such that said at least one fastener engages the first plate, the second plate, or combinations thereof in an interference fit.

4. The rotor apparatus of claim 1, wherein the plurality of laminations comprises a first lamination having a first region with a thickness greater than a second region thereof, and a second lamination having a third region with a thickness greater than a fourth region thereof, wherein the first region of the first lamination is positioned above the fourth region of the second lamination, and wherein the second region of the first lamination is positioned above the third region of the second lamination to form a first stacked pair of laminations.

5. The rotor apparatus of claim 4, wherein the plurality of laminations further comprises a second stacked pair of laminations, and wherein the second stacked pair of laminations is rotationally offset relative to the first stacked pair of laminations.

6. The rotor apparatus of claim 4, wherein the first lamination comprises a first top face and a first bottom face, wherein the second lamination comprises a second top face and a second bottom face, and wherein the first bottom face is positioned in contact with the second top face.

7. The rotor apparatus of claim 1, wherein said at least one fastener and said at least one orifice define an envelope comprising a maximum space able to be occupied by said at least one fastener to reduce contact between said at least one fastener and the plurality of laminations during rotation of the rotor apparatus, and wherein said at least one fastener comprises a volume of material less than a volume of the envelope for reducing a moment of inertia of said at least one fastener.

8. The rotor apparatus of claim 7, wherein said at least one fastener comprises a cylindrical body having an axial bore therein thereby providing said at least one fastener with.

9. The rotor apparatus of claim 7, wherein said at least one fastener comprises a cylindrical body having at least one notch formed in a periphery thereof.

10. The rotor apparatus of claim 1, further comprising at least one securing member engaged with said at least one fastener and applying an axial load thereto.

11. A method for forming a rotor apparatus, the method comprising the steps of:
orienting a plurality of laminations in vertical alignment, wherein the plurality of laminations comprise a center and at least one orifice spaced a distance from the center; and
passing at least one fastener through said at least one orifice, wherein said at least one fastener, said at least one orifice, or combinations thereof are sized to reduce contact between said at least one fastener and the plurality of laminations during rotation of the rotor apparatus.

12. The method of claim 11, wherein the step of orienting the plurality of laminations comprises placing a first plate in contact with a first side of the plurality of laminations and placing a second plate in contact with a second side of the plurality of laminations, the method further comprising the step of engaging said at least one fastener with a first opening in the first plate and a second opening in the second plate to compressively retain the plurality of laminations.

13. The method of claim 12, wherein the step of engaging said at least one fastener with the first opening and the second opening comprises engaging said at least one fastener with the first plate, the second plate, or combinations thereof via an interference fit.

14. The method of claim 11, wherein the step of orienting the plurality of laminations comprises positioning a thicker region of a first lamination over a thinner region of a second lamination and positioning a thinner region of the first lamination over a thicker region of the second lamination to form a first stacked pair of laminations.

15. The method of claim 14, wherein the step of orienting the plurality of laminations further comprises positioning a second stacked pair of laminations above the first stacked pair of laminations and rotationally offsetting the second stacked pair of laminations relative to the first stacked pair of laminations.

16. The method of claim 14, wherein the step of orienting the plurality of laminations further comprises contacting a top face of the second lamination with a bottom face of the first lamination.

17. The method of claim 11, wherein said at least one fastener and said at least one orifice define an envelope comprising a maximum space able to be occupied by said at least one fastener to reduce contact between said at least one fastener and the plurality of laminations during rotation of the rotor apparatus, the method further comprising the step of providing said at least one fastener with a volume of material less than a volume of the envelope for reducing a moment of inertia of said at least one fastener.

18. The method of claim 11, further comprising the step of engaging at least one securing member to said at least one fastener to apply an axial load thereto.

19. A rotor apparatus comprising:
a plurality of laminations comprising a center and at least one orifice spaced a distance from the center;
a first plate positioned on a first side of the plurality of laminations and comprising at least one first opening aligned with said at least one orifice;
a second plate positioned on a second side of the plurality of laminations and comprising at least one second opening aligned with said at least one orifice; and
at least one fastener engaged with said at least one first opening and said at least one second opening and extending through said at least one orifice, wherein said at least one fastener and said at least one orifice define an envelope comprising a maximum space able to be occupied by said at least one fastener to reduce contact between said at least one fastener and the plurality of laminations during rotation of the rotor apparatus, and wherein said at least one fastener comprises a volume of material less than a volume of the envelope for reducing a moment of inertia of said at least one fastener.

20. The rotor apparatus of claim 19, wherein said at least one fastener comprises a cylindrical body having an axial bore therein.
